(19) United States
(12) Patent Application Publication
(10) Pub. No.: US 2015/0010196 A1
(43) Pub. Date: Jan. 8, 2015

(54) Three-Magnet Type Microspeaker

(71) Applicant: EM-TECH. Co., Ltd., Busan (KR)

(72) Inventors: Hyun Woo Lee, Changwon-si (KR); Ho Yun Lee, Busan (KR); Joong Hak Kwon, Gimhae-si (KR)

(21) Appl. No.: 14/321,210

(22) Filed: Jul. 1, 2014

(30) Foreign Application Priority Data
Jul. 2, 2013 (KR) 10-2013-0077032

(51) Int. Cl. H04R 15/00

(52) U.S. Cl. CPC H04R 15/00; H04R 2209/041
USPC 381/412

(57) ABSTRACT

A three-magnet type microspeaker includes: a frame; a yoke coupled to the frame to form a bottom surface; a center magnet secured to a top of the yoke; a pair of side magnets secured to the top of the yoke and disposed at both sides of the center magnet; a center top plate attached to a top of the center magnet; side top plates attached to a top of the side magnets; a voice coil having a bottom end disposed in a gap between the center magnet and the side magnets and in a gap between the center magnet and a bending part; and a diaphragm vibrating due to the voice coil. The yoke includes a bending part bent upwardly at a distance from the end of the center magnet, on a side where the side magnets are not disposed, the bending part being wider than the voice coil.

### PRIORITY CLAIM

The present application claims priority to Korean Patent Application No. 10-2013-0077032 filed on 2 Jul. 2013, the content of said application incorporated herein by reference in its entirety.

### TECHNICAL FIELD

The present invention relates to a three-magnet type microspeaker which includes a center magnet and a pair of side magnets disposed at both sides of the center magnet.

### BACKGROUND

Dynamic speakers can be roughly divided into a single-magnet type speaker, an inner and outer ring magnet type speaker, and a three-magnet type speaker according to the structure of a magnetic circuit.

FIG. 1 shows the structure of a conventional magnetic circuit using an inner ring magnet. A magnet 20 is provided on a yoke 10, and a plate 22 is attached to the top of the magnet 20. The magnet 20 is disposed inside a voice coil 30, and the yoke 10 is bent upwardly on the outside of the voice coil 30, thus forming a magnetic path. However, this single-magnet type magnetic circuit, i.e., the conventional magnetic circuit using the inner or outer ring magnet has a disadvantage in that an electromagnetic force is small.

FIG. 2 shows the structure of a conventional inner and outer ring magnet type magnetic circuit which includes a combination of an inner ring magnet and an outer ring magnet. In this magnetic circuit, an inner ring magnet 20′ and an annular outer ring magnet 24, which have opposite directions, are attached to the top of a planar yoke 10′, and top plates 22′ and 24′ are attached to the top of the magnets, respectively, thus forming a magnetic path. However, the conventional magnetic circuit which includes the combination of the inner ring magnet and the annular outer ring magnet has a disadvantage in that it is difficult and expensive to manufacture the annular outer ring magnet.

FIG. 3 shows the structure of a conventional three-magnet type magnetic circuit. In this magnetic circuit, a bar-shaped center magnet 22″ is attached to the top of a rectangular planar yoke 10″, and side magnets 21″ and 23″ are attached thereto on the outside of a coil side by side with the center magnet 22″. The conventional three-magnet type magnetic circuit using the three bar-shaped magnets is advantageous in terms of the price and performance. However, it is mostly applicable to the cases with a large ratio of a long axis to a short axis, since a magnetic field on the short axes is wasted.

Additionally, in the case of the conventional three-magnet type magnetic circuit, the side magnets 21″ and 23″ are attached to the top of the yoke 10″ by means of an adhesive such as a bond, and the side top plates 24″ and 26″ are also attached to the top of the side magnets 21″ and 23″ by means of an adhesive such as a bond. If a strong impact is applied from the outside to the magnetic circuit, the bond-attached parts may be detached and move inwardly, i.e., toward the center magnet 22″, such that a sufficient air gap may not be obtained. Further, the bond-attached parts may apply an impact to the voice coil, which leads to defects such as joint failure, wire break, etc. of the voice coil.

In order to solve the foregoing problems, stepped portions may be provided on the periphery of the side magnets 21″ and 23″ and covered with injection portions of a frame during formation of the frame so as to prevent detachment of the side magnets 21″ and 23″. However, there is a disadvantage in that the addition of a process for forming the stepped portions on the side magnets 21″ and 23″ increases the unit price of the product.

### SUMMARY

A structure is provided for preventing detachment of side magnets in a three-magnet type microspeaker.

According to an embodiment, there is provided a three-magnet type microspeaker, including: a frame; a yoke coupled to the frame to form a bottom surface; a center magnet attached on the yoke; a pair of side magnets attached on the yoke and disposed at both sides of the center magnet; a center top plate attached to the top of the center magnet; side top plates attached to the top of the side magnets; a voice coil having a bottom end disposed in the gap between the center magnet and the side magnet and in the gap between the center magnet and a bending part, the voice coil vibrating due to a mutual electromagnetic force; and a diaphragm vibrating due to the voice coil, wherein the yoke includes the bending part, which is bent upwardly at a certain distance from the end of the center magnet, on the side where the side magnet is not disposed, the bending part being wider than the voice coil.

In addition, the side magnet is longer than the center magnet.

Moreover, the yoke further includes a protrusion, which is bent upwardly on the outside of the side magnet, on the side where the side magnet is disposed.

Additionally, the top surface of the bending part is equal to or higher than the top surface of the side top plate.

Further, the top end of the bending part is as high as the top surface of the side magnet, and the side top plate is formed in an annular shape to cover the top surfaces of the side magnet and the bending part.

Furthermore, an upper portion of the bending part is configured such that a center portion, that is as high as the top surface of the side top plate, and both ends, that are as high as the top surfaces of the side magnets, can have a step difference, and the side top plate includes an extension which is extended toward the bending part to cover the top surface of the side magnet and the top surfaces of both ends of the bending part.

According to another embodiment, there is provided a three-magnet type microspeaker, including: a frame; a yoke coupled to the frame to form a bottom surface; a center magnet attached on the yoke; a pair of side magnets attached on the yoke and disposed at both sides of the center magnet; a center top plate attached to the top of the center magnet; side top plates attached to the top of the side magnets; a voice coil having a bottom end disposed in the gap between the center magnet and the side magnet and in the gap between the center magnet and a bending part, the voice coil vibrating due to a mutual electromagnetic force; and a diaphragm vibrating due to the voice coil, wherein the yoke includes a bending part, which is bent upwardly at a certain distance from the end of the center magnet, on the side where the side magnet is not disposed, the bending part being in contact with the inside of the side magnet.

In addition, part of the inside of the side magnet is cut away, and the bending part is received in the cutaway portion of the side magnet.

According to a further embodiment, there is provided a three-magnet type microspeaker, including: a frame; a yoke coupled to the frame to form a bottom surface; a center magnet attached on the yoke; a pair of side magnets attached on the yoke and disposed at both sides of the center magnet; a center top plate attached to the top of the center magnet; side top plates attached to the top of the side magnets; a voice coil having a bottom end disposed in the gap between the center magnet and the side magnet and in the gap between the center magnet and a bending part, the voice coil vibrating due to a mutual electromagnetic force; and a diaphragm vibrating due to the voice coil, wherein the yoke includes a bending part, which is bent upwardly at a certain distance from the end of the center magnet, on the side where the side magnet is not disposed, the bending part being disposed between the pair of side magnets.

Moreover, the bending part is curved so that both ends can be close to the center magnet.

In the three-magnet microspeaker provided by the present invention, the bending part of the yoke guides the inside of the side magnet. As a result, even if the side magnet is detached from the initial position due to a bond or adhesive failure, it is prevented from moving toward the center magnet, i.e., into the magnetic circuit and causing air gap defects, or defects such as joint failure, wire break, etc. of the voice coil.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 shows the structure of a conventional magnetic circuit using an inner ring magnet.

FIG. 2 shows the structure of a conventional inner and outer ring magnet type magnetic circuit which includes a combination of an inner ring magnet and an outer ring magnet.

FIG. 3 shows the structure of a conventional three-magnet type magnetic circuit.

FIG. 4 shows a magnetic circuit of a microspeaker according to a first embodiment of the present invention.

FIG. 5 shows the magnetic circuit of the microspeaker according to the first embodiment of the present invention that is secured to a frame.

FIG. 6 shows a magnetic circuit of a microspeaker according to a second embodiment of the present invention.

FIG. 7 shows a magnetic circuit of a microspeaker according to a third embodiment of the present invention.

FIG. 8 shows a magnetic circuit of a microspeaker according to a fourth embodiment of the present invention.

FIG. 9 shows a magnetic circuit of a microspeaker according to a fifth embodiment of the present invention.

FIG. 10 shows a magnetic circuit of a microspeaker according to a sixth embodiment of the present invention.

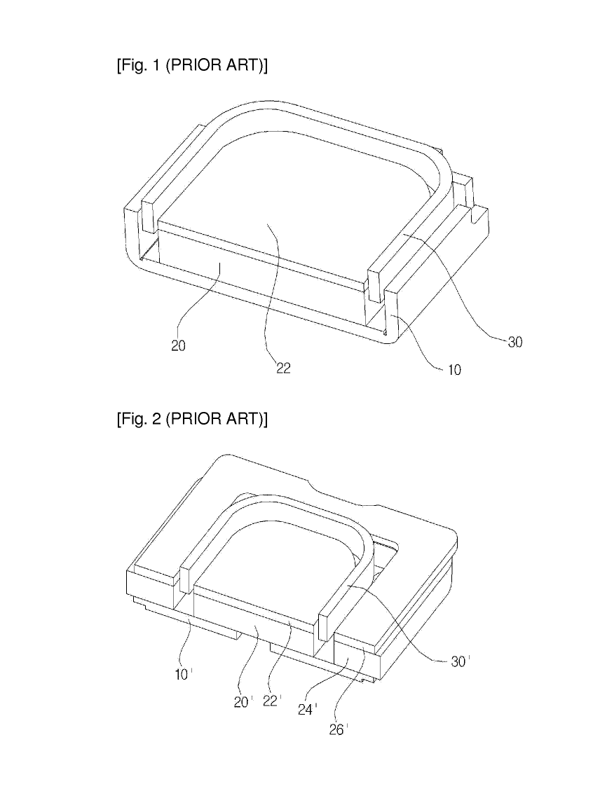

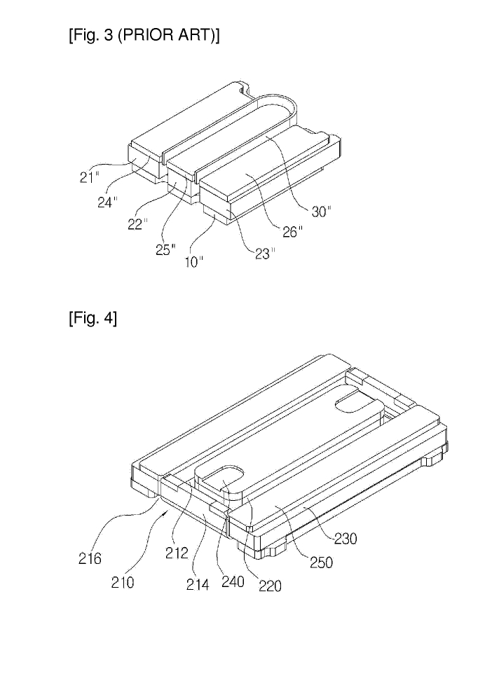

### DETAILED DESCRIPTION

FIG. 4 shows a magnetic circuit of a microspeaker according to a first embodiment of the present invention. In the magnetic circuit according to one embodiment of the present invention, three magnets 220 and 230 are attached to the top of a yoke 210 at certain distances. Among the three magnets, a central magnet 220 is disposed inside a voice coil (not shown), and a pair of side magnets 230 are disposed outside a voice coil (not shown), at both sides of the center magnet 220. Top plates 240 and 250 which assist in forming a magnetic path are attached to the top of the magnets 220 and 230, respectively.

When an electric signal is applied to the voice coil (not shown), the voice coil vibrates in the vertical direction due to a mutual electromagnetic force between the voice coil and the magnetic circuit, as a result of which a diaphragm (not shown) vibrates, producing sounds. The voice coil (not shown) encloses the central magnet 220 at a certain distance, and the bottom end of the voice coil (not shown) is spaced apart from the yoke 210. That is to say, the bottom end of the voice coil (not shown) is disposed in the air gaps between the center magnet 220 and the side magnets 230.

The center magnet 220 and the voice coil (not shown) are formed in a rectangular shape, each having a pair of long sides and a pair of short sides. Each side magnet 230 is also formed in a rectangular shape with a pair of long sides and a pair of short sides, but in a different length ratio than the center magnet 220 and the voice coil (not shown). In addition, the microspeaker itself also has a pair of long sides and a pair of short sides, but in a different length ratio than the center magnet 220, the voice coil (not shown), and the side magnets 230. Although the rectangular shape has been taken as an example, the corners are not necessarily right-angled, but may be rounded or cut off.

The center magnet 220 and the side magnets 230 are disposed side by side, with their long sides facing each other. Therefore, the long side of the voice coil (not shown) is disposed between the long side of the center magnet 220 and the long side of the side magnet 230.

In order to form a magnetic path on the short side of the voice coil (not shown), part of the yoke 210 disposed on the outside of the short side of the voice coil (not shown) is bent upwardly from a bottom surface 212, thus making a bending part 214. The bending part 214 and the short side of the center magnet 220 are spaced apart from each other, and the bottom end of the voice coil (not shown) on the short side is disposed in the gap between the bending part 214 of the yoke 210 and the center magnet 220. This structure can overcome a disadvantage of the existing bar-shaped magnetic circuit that the magnetic path is not formed on the short sides of the voice coil (not shown).

In addition, the bending part 214 is disposed between the pair of side magnets 230. Preferably, the bending part 214 is wider than the voice coil 300. Thus, even if the side magnets 230 that are attached to the bottom surface 212 of the yoke 210 by means of an adhesive, such as a bond or double-sided tape, are detached from the bottom surface 212 due an impact, they can be stopped by the bending part 214 not to move inwardly, i.e., toward the center magnet 220 and damage the voice coil (not shown).

Here, the bending part 214 is spaced apart from the short side of the center magnet 220, but should be brought into contact with the inside of the side magnet 230 or should be able to guide the inside of the side magnet 230. Accordingly, the side magnets 230 are longer than the center magnet 220.

Meanwhile, in order to facilitate bending of the bending part 214, a groove 216 may be provided on the outside in the width direction of the bending part 214.

FIG. 5 shows the magnetic circuit of the microspeaker according to the first embodiment of the present invention that is secured to a frame 100.

In the microspeaker according to one embodiment of the present invention, the magnetic circuit composed of the yoke 210, the center magnet 220, the side magnets 230, the center top plate 240 and the side top plates 250 is secured to the frame 100.

In a state where the center magnet 220, the side magnets 230 and the like are attached to the yoke 210, the magnetic circuit can be insert injection-molded during the injection molding of the frame 100, or alternatively, the separate magnetic circuit can be coupled to the injection-molded frame 100.

In the meantime, the yoke 210 may further include, in addition to the bending part 214, a protrusion 218 which protrudes more outwardly than the attachment position of the side magnet 230 so as to prevent the side magnet 230 from moving inwardly. The protrusion 218 can be inserted into the injection portion of the frame 100 during the injection molding of the frame 100 so as to prevent the yoke 210 from being detached from the frame 100.

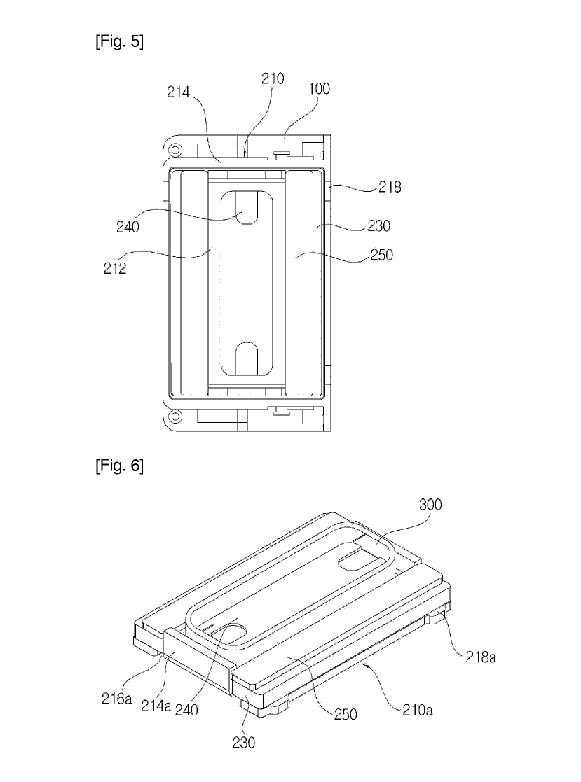

FIG. 6 shows a magnetic circuit of a microspeaker according to a second embodiment of the present invention. The shape and structure of the components of the second embodiment are identical to those of the first embodiment, except for the shape of a yoke 210a. Thus, an explanation of the components other than the yoke 210a will be omitted.

As in the first embodiment, the yoke 210a provided in the microspeaker according to the second embodiment of the present invention includes a bending part 214a which is formed by bending part of the yoke 210, that is disposed on the outside of the short side of the voice coil (not shown), upwardly from the bottom surface (not shown) so as to form a magnetic path on the short side of the voice coil (not shown), a groove 216a which is formed on the outside in the width direction of the bending part 214a so as to facilitate bending of the bending part 214a, and a protrusion 218a which protrudes more outwardly than the attachment position of the side magnet 230.

Here, the difference between the first and second embodiments is that the top surface of the bending part 214a is higher than the top surface of the side top plate 250. Preferably, the top surface of the bending part 214a is at least equal to or lower than the top surface of the frame (not shown) so as not to interrupt coupling of a protector (not shown) and a frame (not shown).

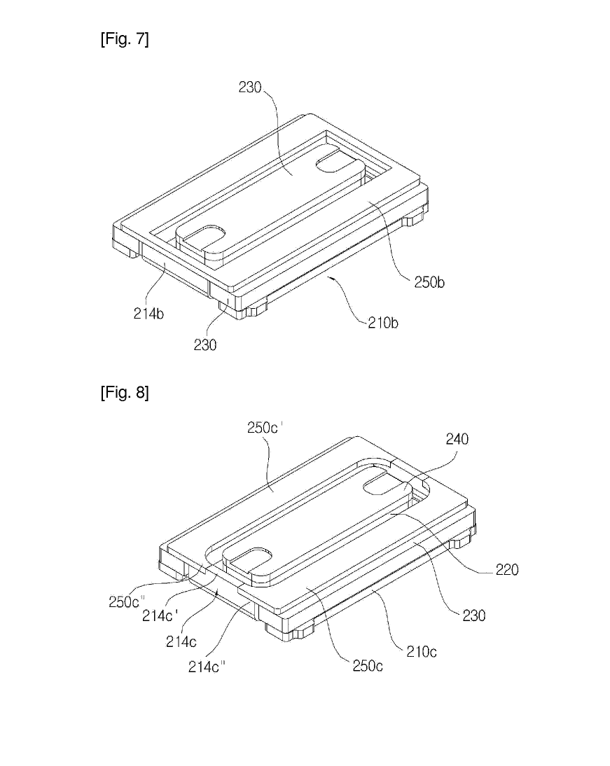

FIG. 7 shows a magnetic circuit of a microspeaker according to a third embodiment of the present invention. The shape and structure of the components of the third embodiment are identical to those of the first embodiment, except for the shape of a yoke 210b and a side top plate 250b. Thus, an explanation of the components other than the yoke 210b and the side top plate 250b will be omitted.

A top end of a bending part 214b of the yoke 210b is as high as the top surface of the side magnet 230. Moreover, the side top plate 250b is formed in an annular shape to cover the top surface of the side magnet 230 and the bending part 214b. Accordingly, the side top plate 250b assists in forming a magnetic path between the bending part 214b and the center magnet 220, which results in an improved performance of the microspeaker.

FIG. 8 shows a magnetic circuit of a microspeaker according to a fourth embodiment of the present invention. The shape and structure of the components of the fourth embodiment are identical to those of the first embodiment, except for the shape of a yoke 210c and a side top plate 250c. Thus, an explanation of the components other than the yoke 210c and the side top plate 250c will be omitted.

A bending part 214c of the yoke 210c is configured that a center portion 214c′ and both ends 214c″ can have a step difference. The top end of the center portion 214c′ is as high as the top surface of the side top plate 250c, while both ends 214c″ thereof are as high as the top surfaces of the side magnets 230. The side top plate 250c includes a portion 250c′, which is attached to the top surface of the side magnet 230, and an extension 250c″, which serves to cover both ends 214c″ of the bending part 214c. Accordingly, the bending part 214c guides the installation positions of the side top plates 250c, and at the same time, the side top plates 250c assist in forming a magnetic path between the bending part 214b and the center magnet 220, which results in an improved performance of the microspeaker.

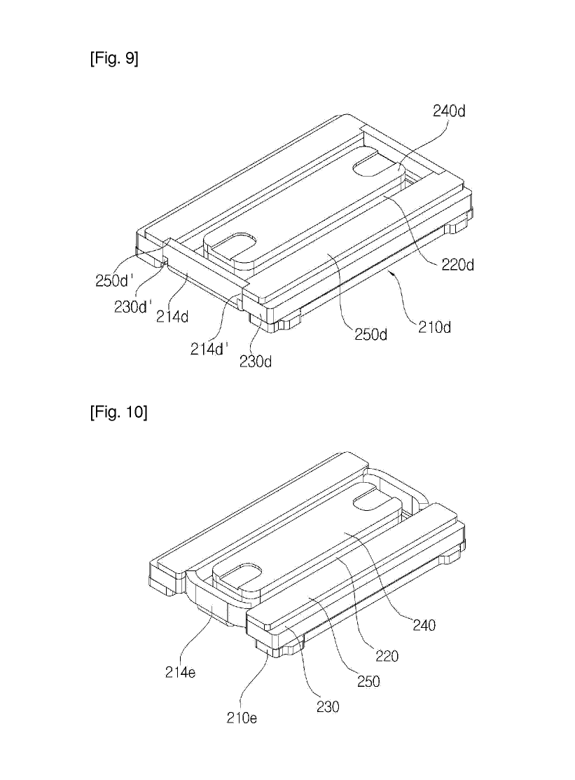

FIG. 9 shows a magnetic circuit of a microspeaker according to a fifth embodiment of the present invention. The shape and structure of the components of the fifth embodiment are identical to those of the first embodiment, except for the shape of a yoke 210d, a side magnet 230d, and a side top plate 250d. Thus, an explanation of the components other than the yoke 210d, the side magnet 230d and the side top plate 250d will be omitted.

The side magnet 230d and the side top plate 250d include cutaway portions 230d′ and 250d′, and the bending part 214d is received in the cutaway portions of the side magnet 230d and the side top plate 250d. Therefore, there is an advantage in that the bending part 214d, the side magnet 230d and the side top plate 250d can be easily matched in shape.

FIG. 10 shows a magnetic circuit of a microspeaker according to a sixth embodiment of the present invention. The shape and structure of the components of the sixth embodiment are identical to those of the first embodiment, except for the shape of a yoke 210e. Thus, an explanation of the components other than the yoke 210e will be omitted.

Both ends of a bending part 214e of the yoke 210e according to the sixth embodiment of the present invention are curved inwardly not to become distant from the center magnet 220. Generally, the respective corners of the center magnet 220 are rounded. Preferably, both ends of the bending part 214e are curved concentric to the rounded corners of the center magnet 220, so that a distance between the center magnet 220 and the bending part 214e can be maintained constant from the center portion to both ends of the bending part 214e.

Spatially relative terms such as “under”, “below”, “lower”, “over”, “upper” and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A three-magnet type microspeaker, comprising:
a frame;
a yoke coupled to the frame to form a bottom surface;
a center magnet attached to a top of the yoke;
a pair of side magnets attached to the top of the yoke and disposed at both sides of the center magnet;
a center top plate attached on the center magnet;
side top plates attached on the side magnets;
a voice coil having a bottom end disposed in a gap between the center magnet and the side magnets and in a gap between the center magnet and a bending part of the yoke, the voice coil vibrating due to a mutual electromagnetic force; and
a diaphragm vibrating due to the voice coil,
wherein the yoke comprises the bending part, which is bent upwardly at a distance from the end of the center magnet, on a side where the side magnets are not disposed, the bending part being wider than the voice coil.

2. The three-magnet type microspeaker of claim 1, wherein the side magnets are longer than the center magnet.

3. The three-magnet type microspeaker of claim 1, wherein the yoke further comprises a protrusion which protrudes more outwardly than an attachment position of the side magnets, on the side where the side magnets are disposed.

4. The three-magnet type microspeaker of claim 1, wherein a top surface of the bending part is equal to or higher than a top surface of the side top plates.

5. The three-magnet type microspeaker of claim 1, wherein a top end of the bending part is as high as a top surface of the side magnets, and the side top plate is formed in an annular shape to cover the top surfaces of the side magnet and the bending part.

6. The three-magnet type microspeaker of claim 1, wherein an upper portion of the bending part is configured such that a center portion, that is as high as a top surface of the side top plate, and both ends, that are as high as a top surface of the side magnets, has a step difference, and the side top plate comprises an extension which is extended toward the bending part to cover the top surface of the side magnets and the top surface of both ends of the bending part.

7. A three-magnet type microspeaker, comprising:
a frame;
a yoke coupled to the frame to form a bottom surface;
a center magnet attached to a top of the yoke;
a pair of side magnets attached to the top of the yoke and disposed at both sides of the center magnet;
a center top plate attached on the center magnet;
side top plates attached on the side magnets;
a voice coil having a bottom end disposed in a gap between the center magnet and the side magnets and in a gap between the center magnet and a bending part of the yoke, the voice coil vibrating due to a mutual electromagnetic force; and
a diaphragm vibrating due to the voice coil,
wherein the yoke comprises the bending part, which is bent upwardly at a distance from the end of the center magnet, on a side where the side magnets are not disposed, the bending part being in contact with the inside of the side magnets.

8. The three-magnet type microspeaker of claim 7, wherein part of the inside of the side magnets is cut away, and the bending part is received in the cutaway portion of the side magnets.

9. A three-magnet type microspeaker, comprising:
a frame;
a yoke coupled to the frame to form a bottom surface;
a center magnet attached on the yoke;
a pair of side magnets attached on the yoke and disposed at both sides of the center magnet;
a center top plate attached to a top of the center magnet;
side top plates attached to a top of the side magnets;
a voice coil having a bottom end disposed in a gap between the center magnet and the side magnets and in a gap between the center magnet and a bending part of the yoke, the voice coil vibrating due to a mutual electromagnetic force; and
a diaphragm vibrating due to the voice coil,
wherein the yoke comprises the bending part, which is bent upwardly at a distance from the end of the center magnet, on a side where the side magnets are not disposed, the bending part being disposed between the pair of side magnets.

10. The three-magnet type microspeaker of claim 9, wherein the bending part is curved so that both ends of the bending part are close to the center magnet.
